(19) United States
(12) Patent Application Publication
(10) Pub. No.: US 2012/0164473 A1
(43) Pub. Date: Jun. 28, 2012

(54) THERMAL BARRIER COATINGS

(76) Inventors: Mary Taylor, Birmingham (GB); Hugh Evans, Ashleworth (GB); Simon Gray, Bedford (GB); John Nicholls, Great Horwood (GB)

(21) Appl. No.: 13/147,533

(22) PCT Filed: Feb. 24, 2010
(86) PCT No.: PCT/GB10/00326

§ 371 Date: Mar. 15, 2012

(30) Foreign Application Priority Data
Feb. 25, 2009 (GB) 0903199.8

(51) Int. Cl. B32B 15/04; B05D 1/36; B05D 1/38

(52) U.S. Cl. 428/623; 428/686; 428/632; 427/405

(57) ABSTRACT

Coated products are described comprising a metallic substrate, an aluminium-rich layer, a chromia-forming layer and a thermally insulating top coat. The chromia-forming layer is located between the substrate and the thermally-insulating top coat. The aluminium-rich layer is located between the substrate and the chromia-forming layer. The coating may be used to provide protection of parts exposed to conditions of relatively high temperatures, heat flux, and/or corrosive environments, such as the conditions in industrial gas turbines using poorer-quality fuels (such as bio-fuels).

The present invention relates to coatings for metallic substrates. Such coatings may be thermally-insulating and may find application in protection of surfaces used in industrial processes where they are exposed to high temperatures, heat flux, and/or corrosive environments.

One common application for thermally-insulating coatings is in the protection of gas turbine components, such as turbine blades. Such components are commonly formed from high-temperature superalloys, based on iron-, cobalt- or nickel-rich compositions. These compositions are optimised for mechanical properties, such as creep and fatigue resistance, in highly stressed components. However, the alloys are not able to withstand oxidative or corrosive attack for any significant periods of time.

In order to overcome this deficiency, it is known to apply a protective coating to the component. One such coating consists of a bond coat of MCrAlY alloy (where M is Ni and/or Co) covered by a top coat of yttria-stabilised zironia (YSZ). The YSZ top coat has a low thermal conductivity and so reduces exposure of the component to the high environmental temperatures, especially when coupled with internal cooling systems.

Alternatively, the surface of the component may be enriched with aluminium to form a bond coat, either by physical deposition onto the component (substrate) or by vapour diffusion. Some of these processes may also apply other beneficial elements, such as platinum. The bond coat is then covered by a top coat as above.

The initial aluminium concentration in the bond coats produced by these methods ranges from 10 to 55 atomic %.

In all known cases, whether involving application of a separate bond coat or surface enrichment with aluminium, exposure of the coated article to operating conditions within the gas turbine causes growth of a continuous layer of alumina at the interface between the bond coat and the top coat, using aluminium present in the bond coat. This alumina layer aids in mechanical retention of the YSZ top coat, and protects the component from oxidative damage at the high temperatures (above 900° C.) experienced, effectively sealing the surface from further damage, and can also aid in mechanical retention of the YSZ top coat, especially in the early stages. The process of alumina formation on the bond coat depletes the bond coat of aluminium; however, the level of aluminium present in the initial bond coat is sufficient to last the lifetime of the component.

However, the alumina layer is not as successful in protecting turbine components from oxidative damage at intermediate temperatures (approximately 600 to 900° C.), and/or from corrosive conditions, such as can be found in industrial gas turbines utilising poorer-quality fuels (particularly bio-fuels). As a result, the ability to use such fuels is limited, and turbines are often forced to run at lower temperatures to minimise corrosion, thereby reducing efficiency. There is therefore a need for a protective coating which is optimised for use in corrosive or intermediate-temperature oxidative conditions.

According to a first aspect of the invention, there is provided a coated product comprising a metallic substrate, an aluminium-rich layer, a chromia-forming layer, and optionally a thermally-insulating coat; wherein the chromia-forming layer is located between the substrate and the thermally-insulating coat (or outer surface, where the thermally-insulating coat is not present), and the aluminium-rich layer is located between the substrate and the chromia-forming layer.

As used herein, a ‘chromia-forming layer’ is intended to refer to a layer of material, typically an alloy, which, on exposure to an oxidative environment at intermediate temperatures (e.g. approximately 600 to 900° C.) will form a layer of chromia. It will therefore be understood that the chromia-forming layer must contain chromium in some form. In some embodiments, the chromia-forming layer is rich in chromium and poor in aluminium. The requirements in regard to other chemical species will be readily apparent to the skilled person.

In some embodiments, the chromium content of the chromia-forming layer is at least 30 atomic %. In some further embodiments, the chromium content of the chromia-forming layer is at least 40 atomic % or at least 50 atomic %. In some further embodiments, the chromium content of the chromia-forming layer is from 50 to 90 atomic %.

As used herein, ‘aluminium-poor’ (such as in relation to a chromium-rich, aluminium-poor layer) is intended to mean that the aluminium content is sufficiently low not to disrupt chromia formation. In some embodiments, the aluminium content of the chromia-forming layer is less than 5 atomic %, less than 3 atomic %, less than 2 atomic % or less than 1 atomic %.

Conversely, it will be appreciated that ‘aluminium-rich’ is intended to mean that the aluminium content is sufficiently high that, under oxidative conditions, alumina is formed in addition to, or instead of, chromia. In some embodiments, the aluminium-rich layer is an alumina-forming layer, i.e. a layer of material, typically an alloy, which, on exposure to an oxidative environment will form a layer of alumina.

In some embodiments, the thermally-insulating coat comprises yttria-stabilised zirconia. In some further embodiments, the thermally-insulating coat consists substantially of yttria-stabilised zirconia.

In some embodiments, the chromia-forming layer comprises a layer in a bond coat located between the substrate and the thermally-insulating coat. In some further embodiments, the chromia-forming layer is located at the surface of the bond coat nearest the thermally-insulating coat, such as at the interface of the bond coat with the thermally-insulating coat.

In some embodiments, the bond coat comprises a first layer which is not chromia-forming, and a second layer which is chromia-forming. In some further embodiments, the second layer is located between the first layer and the thermally-insulating coat. The aluminium-rich layer may form the first layer. For example, the first layer may comprise MCrAlY, where M is selected from Ni, Co, and a mixture thereof. Alternatively, the first layer may comprise MCrAlY which has been enriched in aluminium. The second layer may comprise a layer of NiCr alloy. Alternatively or additionally, the second layer may comprise a layer of non-chromia-forming material (such as the material of the first layer) which has been chemically altered (such as by enrichment with chromium) such that it is chromia-forming.

In some still further embodiments, the bond coat further comprises a third layer located between the first and second layers. The third layer may be-aluminium rich. In particular, the third layer may have a greater aluminium content than the first layer.

It will be understood that the bond coat may comprise further (unspecified) layers.

In some alternative embodiments, the bond coat consists substantially of a single chromia-forming layer, such as a single layer which is chromium-rich and aluminium poor. For example, the bond coat may consist of a single layer of a chromium-rich, aluminium-poor alloy such as NiCr. In such cases, the aluminium-rich layer will be located between the substrate and the bond coat, or will form part of the substrate. For example, the aluminium-rich layer may be a surface layer of the substrate. In some further embodiments, the aluminium-rich layer is enriched in aluminium relative to the remainder of the substrate.

In some embodiments, the chromia-forming layer is a surface layer of the substrate, and the aluminium-rich layer is a sub-surface layer of the substrate. In some further embodiments, the chromia-forming layer is enriched in chromium relative to the substrate. In some further embodiments, the aluminium-rich layer is enriched in aluminium relative to the substrate. It will be understood that such structures may be made by aluminising a surface region of the substrate (if necessary), and then chromising a surface region of the alumised layer.

The metallic substrate may be a metal or alloy. In some embodiments, the metallic substrate comprises a metal or alloy well suited to use in manufacture of gas turbine components, such as for example a high temperature superalloy.

In some embodiments, the coated product is a gas turbine component.

According to a second aspect of the invention, there is provided a coated product obtainable from the coated product of the first aspect of the invention, comprising a metallic substrate, optionally a thermally-insulating coat, a continuous layer of chromia located between the substrate and the thermally-insulating coat (or the outer surface, where the thermally-insulating coat is not present), and an aluminium-rich layer located between the substrate and the continuous layer of chromia.

It will be understood that, in some embodiments, a product according to the second aspect will result from use of a product according to the first aspect in industrial gas turbines (or the like) operating at intermediate temperatures under oxidative conditions.

In one embodiment, the thermally-insulating coat comprises yttria-stabilised zirconia. In a further embodiment, the thermally-insulating coat consists substantially of yttria-stabilised zirconia.

In some embodiments, the coated product further comprises a bond coat located between the continuous layer of chromia and the substrate.

In some further embodiments, the aluminium-rich layer may form part of the bond coat. For example, the bond coat may comprise MCrAlY, where M is selected from Ni, Co, and a mixture thereof.

In some further embodiments, the bond coat comprises a chromium-rich, aluminium-poor layer. It will be understood that, in some embodiments, the bond coat may comprise both a chromium-rich, aluminium-poor layer, and an aluminium-rich layer. In such cases, the aluminium-rich layer may be located between the substrate and the chromium-rich, aluminium-poor layer.

In some embodiments, the metallic substrate comprises a metal or alloy well suited to use in manufacture of gas turbine components, such as for example a high temperature superalloy.

In some embodiments, the coated product is a gas turbine component.

According to a third aspect of the present invention, there is provided a method of coating a metallic substrate, comprising:

creating an aluminium-rich layer on the substrate;

creating a chromia-forming layer on the aluminium-rich layer; and

optionally, applying a thermally-insulating coat over the chromia-forming layer.

In some embodiments, the chromia-forming layer is rich in chromium and poor in aluminium. The requirements in regard to other chemical species will be readily apparent to the skilled person.

In some embodiments, the chromium content of the chromia-forming layer is at least 30 atomic %. In some further embodiments, the chromium content of the chromia-forming layer is at least 40 atomic % or at least 50 atomic %. In some further embodiments, the chromium content of the chromia-forming layer is from 50 to 90 atomic %.

In some embodiments, the aluminium content of a chromium-rich, aluminium-poor layer is less than 5 atomic %, less than 3 atomic %, less than 2 atomic % or less than 1 atomic %.

In some embodiments, creating an aluminium-rich layer on the substrate comprises applying to the substrate a first bond coat.

It will be understood that the first bond coat may comprise an aluminium-rich layer at the time of application. Additionally, the first bond coat may be further modified post-application, such as for example to modify the aluminium-rich layer to increase the aluminium content, or for any other reason. Alternatively, the aluminium-rich layer may be absent from the first bond coat at the point of application and may be introduced to the first bond coat in a separate process, such as by application of an additional layer to the first bond coat, or by modification of a first bond coat layer such as to increase aluminium content.

In some embodiments, creating a chromia-forming layer on the aluminium-rich layer comprises modifying the aluminium-rich layer to form a chromia-forming layer.

In some embodiments, creating a chromia-forming layer on the aluminium-rich layer comprises applying to the aluminium-rich layer a second bond coat.

It will be understood that the second bond coat may comprise a chromia-forming layer at the time of application. Additionally, the second bond coat may be further modified post-application, such as for example to modify the chromia-forming layer to increase the chromium content, or for any other reason. Alternatively, the chromia-forming layer may be absent from the second bond coat at the point of application and may be introduced to the bond coat in a separate process, such as by application of an additional layer to the bond coat, or by modification of a second bond coat layer such as to increase chromium content, decrease aluminium content, or both.

In some embodiments, modifying the aluminium-rich layer or second bond coat comprises diffusion of chromium atoms into the surface of the aluminium-rich layer or second bond coat.

In some embodiments, modifying the aluminium-rich layer or second bond coat comprises applying a layer of chromium-rich alloy to the surface of the aluminium-rich layer or second bond coat.

In some embodiments, applying to the aluminium-rich layer a second bond coat comprising a chromia-forming layer comprises applying a chromium-rich, aluminium-poor layer. In some embodiments, the aluminium content of the chromium-rich, aluminium-poor layer is less than 5 atomic %, less than 3 atomic %, less than 2 atomic % or less than 1 atomic %. For example, the layer may consist of NiCr. Such a layer may be applied directly to the aluminium-rich layer, or may be applied to a second bond coat layer.

For example, the aluminium-rich layer may comprise MCrAlY, where M is selected from Ni, Co, and a mixture thereof.

In some embodiments, the metallic substrate comprises a metal or alloy well suited to use in manufacture of gas turbine components, such as a high temperature superalloy.

In some embodiments, the method is suitable for producing a gas turbine component.

It will be understood that, in use, exposure of the coated product according to the first aspect of the invention, or a product produced by the method of the third aspect of the invention, to temperatures of between approximately 600 and 900° C. and an oxidative environment causes formation of a continuous layer of chromia at the outer surface of the chromia-forming layer (typically at the interface between the bond coat and the thermally-insulating coat). The chromia is formed by reaction of chromium from the chromia-forming layer with oxygen from the environment. The chromium content of the chromia-forming layer will therefore deplete over time at these temperatures, although the rate of oxidation is relatively slow.

Without wishing to be bound by theory, it is believed that the chromia layer provides increased resistance, when compared to the alumina layer known in the prior art, to both corrosion and oxidation at intermediate temperatures, such as in an industrial gas turbine. This is particularly relevant where penetration of corrosive elements can occur down to the bond coat surface. This may be due to the porous nature of the thermally-insulating coat, or through loss of fragments of the thermally-insulating coat (where present). An alumina layer would be expected to quickly corrode under such circumstances, leaving the unprotected substrate (such as a turbine blade) open to damage.

Should failure occur by significant loss of the thermally-insulating coat in the present invention, the underlying metallic component may experience an increase in temperature to a higher temperature regime where alumina formation would provide the most appropriate oxidative protection. (Similarly, in cases where the thermally-insulating top coat is not present, any increase in temperature may result in such a higher temperature regime). It is to be expected that, under such conditions, the chromia layer will no longer provide sufficient protection. The aluminium-rich layer, initially located between the substrate and the chromia-forming layer, will therefore become exposed to the oxidative atmosphere under such conditions and hence will form a layer of alumina. This may act as a secondary barrier to oxygen ingress, sealing the surface to further attack, and thereby prolonging the lifetime of the coated item. An example of such an aluminium-rich layer would be a base MCrAlY composition of a bond coat.

The invention will be further illustrated by the following example, with reference to the accompanying Figures, in which:

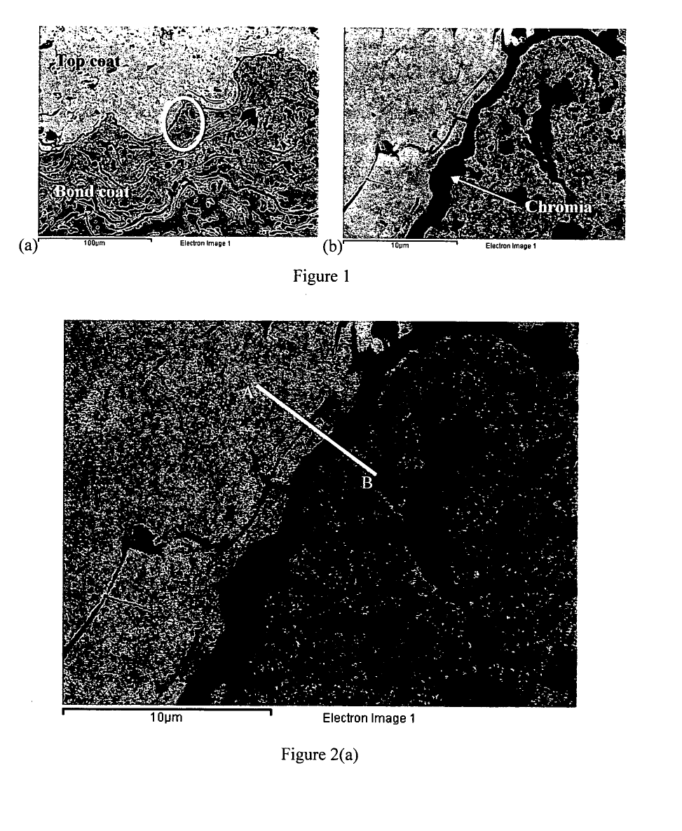

FIG. 1(a) is a scanning electron micrograph image of a section through a coating according to one embodiment of the invention, showing the presence of a bond coat and a thermally-insulating top coat;

FIG. 1(b) is an enlargement of the circled area in FIG. 1(a), showing the presence of a chromia layer;

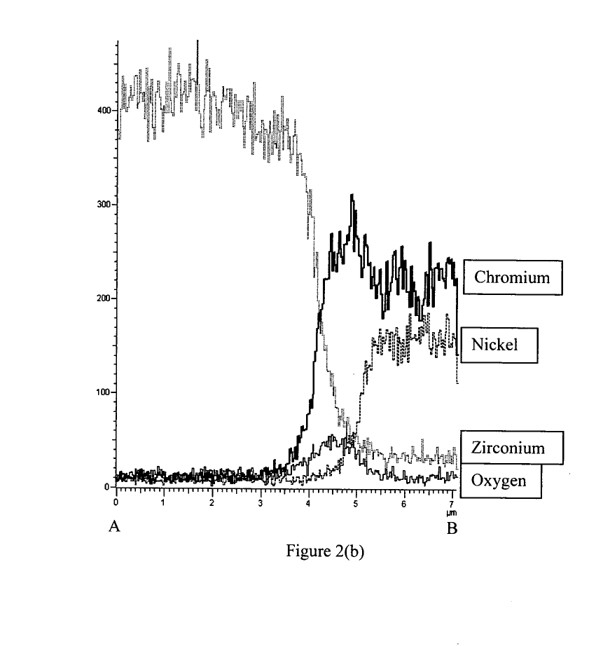

FIG. 2(a) indicates the line of a scan across the chromia layer in FIG. 1(b) from A to B;

FIG. 2(b) indicates the elemental profile along the scan line shown in FIG. 2(a); and

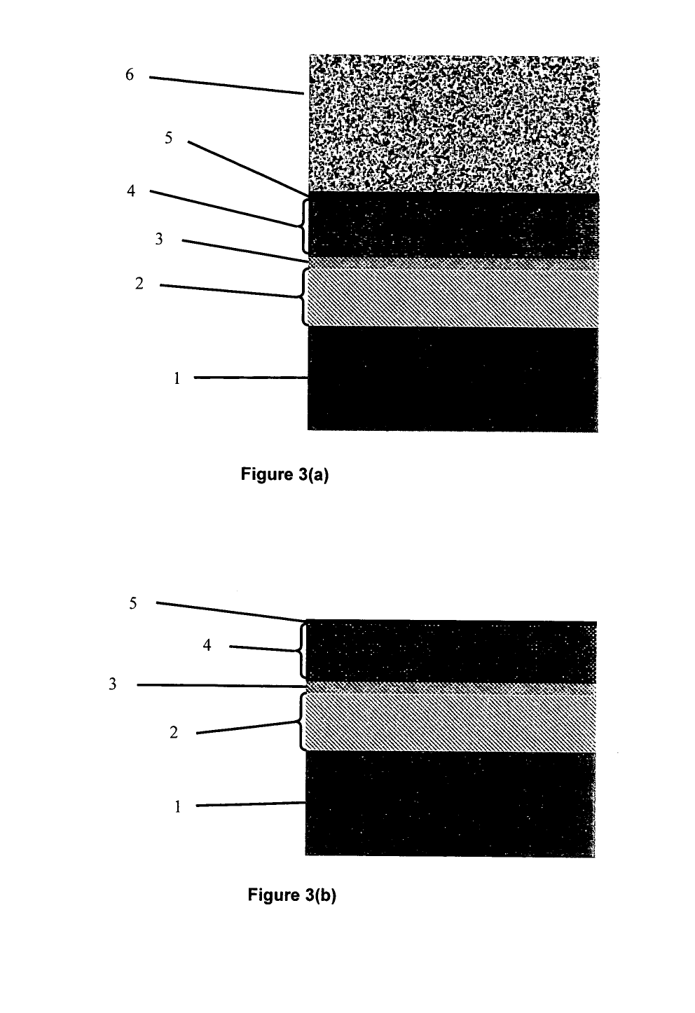

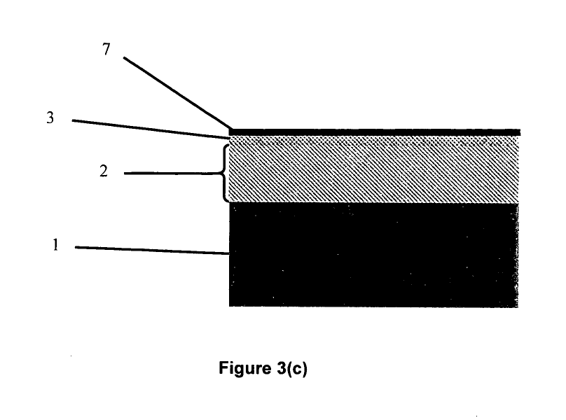

FIGS. 3(a) to (c) are schematic diagrams showing the progressive effects of exposure of a coating according to a second embodiment of the invention to a high temperature corrosive environment.

A 15 mm diameter bar of CMSX-4 (a rhenium-containing, nickel-base single crystal alloy manufactured by Cannon Muskegon Corporation, of Muskegon, Mich., USA and well known in the field of turbine engine component manufacture) was coated with a bond coat of a NiCrAlY composition (approximate composition: weight %: 68.6% Ni, 25% Cr, 6% Al, 0.4% Y; atomic % : 61.8% Ni, 26% Cr, 12% Al, 0.2% Y) to a thickness of between 100 and 150 μm. The surface of the bond coat was then enriched with Cr through deposition of a NiCr alloy (atomic %: 50% Ni, 50% Cr) to a thickness of between 70 and 100 μm. Finally, a thermally-insulating top coat of yttria-stabilised zirconia was applied to the Cr-rich surface. All three coatings (i.e. both layers of the bond coat, and the top coat) were applied using air plasma spraying (APS), and were deposited evenly along the length of the bar (within the tolerance of the coating process).

The coated bar was held in a hot furnace at 750° C., in laboratory air, for 500 h. The specimen bar was then removed from the furnace and examined for signs of cracking or loss of coating during the cooling stage in the test. None was found. The rapid heating and cooling of the bar is an integral part of the testing protocol and is representative of the most severe temperature changes that these coatings are expected to experience during operation.

Following initial analysis, the bar was sectioned into several pieces each approximately 20 mm long. One specimen was prepared for cross-sectional analysis. Scanning electron microscopy confirmed the presence of a layer of pure chromia between the bond coat and the top coat, as shown in FIGS. 1 and 2. The other bars were returned to furnaces set to 750° C., 800° C. and 900° C. for a further 500 h. The samples were then removed from the furnaces, cooled to room temperature and again examined for any visible cracking or coating loss. Again, none was found. Following this success, a further specimen was returned to the furnace set to 750° C. for a further 1300 h (for a total of 1800 h at this temperature). Again, no cracking or coating loss was observed.

FIGS. 3(a) to 3(c) show an alternative embodiment having an aluminium-enriched layer between the bond coat and chromia-forming layer.

A metallic substrate (1)_{—} is coated with a bond coat of MCrAlY (2) as detailed above. This is then coated with a layer of aluminium (3), by means of a technique such as chemical vapour deposition (CVD), pressure vapour deposition (PVD), coating or plating. CVD techniques for deposition of aluminium have been published, such as for example in “Formation of aluminide coatings on nickel by a fluidised bed CVD process”, Voudouris et al, Suface and Coatings Technology, 141 (2001), 275-282. Deposition is also available as a commercial service, such as the low pressure plasma spray overlay, and electron beam physical vapour deposition (EBPVD) provided by hromalloy UK Limited of Alfreton, Derbyshire, UK.

Heat treatment to diffuse the aluminium layer into the MCrAlY bond coat involves either heating to 1050° C. for half an hour, followed by 870° C. for 20 hours, or heating to 1050° C. for 2 hours. Heat treatment cycles vary depending on the substrate alloy, and can be used to restore grain structure as well as diffuse the aluminium coating.

Following deposition of the aluminium, it is coated with a layer NiCr alloy (4) as above, followed by a top coat of yttria-stabilised zirconia (YSZ) (6).

As shown in FIG. 3(a), exposure to an oxidative atmosphere results in the formation of a layer of chromia (5) between the NiCr alloy (4) and the YSZ top coat (6). This layer of chromia (5) acts to prevent corrosion or oxidation of the underlying MCrAlY or substrate.

However, ongoing exposure to the corrosive and oxidative conditions can result in loss of some of the YSZ top coat, as shown in FIG. 3(b), exposing the underlying layers to higher temperatures. Under such conditions, the chromia layer continues to provide some protection, but both it and the underlying NiCr alloy layer will be rapidly oxidised.

Eventually, the NiCr layer is consumed at this location, resulting in exposure of the aluminium layer, as shown in FIG. 3(c). A layer of alumina (7) is rapidly formed at the surface of this layer, and continues to protect the underlying MCrAlY and substrate from oxidation and corrosion. In this way, the useful lifespan of the component (substrate) is prolonged, reducing the frequency with which parts must be removed for recoating.

1. A coated product comprising a metallic substrate, an aluminium-rich layer, a chromia-forming layer, and a thermally-insulating coat; wherein the chromia-forming layer is located between the substrate and the thermally-insulating coat, and the aluminium-rich layer is located between the substrate and the chromia-forming layer.

2. The coated product as claimed in claim 1, wherein the coated product is a gas turbine component.

3. The coated product as claimed in claim 1, wherein the chromia-forming layer is rich in chromium, and poor in aluminium.

4. The coated product as claimed in claim 3, wherein the chromium-rich layer has a chromium content of from 30 to 50 atomic %.

5. The coated product as claimed in claim 1, wherein the aluminium-rich layer is an alumina-forming layer.

6. The coated product as claimed in claim 1, wherein the thermally-insulating coat comprises yttria-stabilised zirconia.

7. A coated product obtainable from the coated product of claim 1, comprising a metallic substrate, a thermally-insulating coat, a continuous layer of chromia located between the substrate and the thermally-insulating coat, and an aluminium-rich layer located between the substrate and the continuous layer of chromia.

8. A method of coating a metallic substrate, comprising:
creating an aluminium-rich layer on the substrate;
creating a chromia-forming layer on the aluminium-rich layer; and
applying a thermally-insulating coat over the chromia-forming layer.

9. The method as claimed in claim 8, wherein creating an aluminium-rich layer on the substrate comprises applying to the substrate a first bond coat.

10. The method as claimed in claim 9, wherein creating an aluminium-rich layer on the substrate further comprises modifying the first bond coat after application to increase the aluminium content of at least part of the first bond coat.

11. The method as claimed in claim 8, wherein creating a chromia-forming layer on the aluminium-rich layer comprises applying to the aluminium-rich layer a second bond coat.

12. The method as claimed in claim 11, wherein the second bond coat comprises a chromia-forming layer at the time of application.

13. The method as claimed in claim 11, wherein creating a chromia-forming layer on the substrate further comprises modification of the second bond coat following application.

14. The method as claimed in claim 8, wherein creating a chromia forming layer on the aluminium-rich layer comprises modifying the aluminium-rich layer to form a chromia forming layer.

15. The method as claimed in claim 13, wherein modification of the second bond coat or aluminium-rich layer comprises diffusion of chromium atoms into the surface of the second bond coat or aluminium-rich layer.

16. The method as claimed in claim 13, wherein modification of the second bond coat or aluminium-rich layer comprises applying a layer of a chromium rich alloy to the surface of the second bond coat or aluminium-rich layer.
